(19) United States
(12) Patent Application Publication
(10) Pub. No.: US 2013/0211664 A1
(43) Pub. Date: Aug. 15, 2013

(54) TIRE MONITORING SYSTEM FOR A VEHICLE

(71) Applicant: Schrader, (US)

(72) Inventors: Nicolas Faivre, Villers Sous Chalamont (FR); Pierre-Antoine Guenot, Saint Gorgon Main (FR)

(73) Assignee: SCHRADER, Pontarlier (FR)

(21) Appl. No.: 13/765,932

(22) Filed: Feb. 13, 2013

(30) Foreign Application Priority Data
Feb. 14, 2012 (FR) 1251351

(51) Int. Cl. G07C 5/08

(52) U.S. Cl. CPC G07C 5/0858
USPC 701/33.3

(57) ABSTRACT

A tire monitoring system mounted on a vehicle comprising at least one sensor mounted in one of the tires in order to measure at least the temperature and the pressure of the tire, transmit the data measured to a central unit mounted on board the vehicle, with the central unit storing the data acquired at various instants. It further comprises a USB port, and the central unit is programmed to, when a removable memory device is connected to the USB port, transfer at least a portion of the data stored in the central unit to the memory device.

### RELATED APPLICATION

The present application claims priority to French Application No. 1251351 filed Feb. 14, 2012, which is incorporated herein in its entirety by reference.

### TECHNICAL FIELD

This invention relates to a tire monitoring system, comprising in particular pressure and temperature sensors of tires that transmit the measurements to a central unit that records the data.

In the description hereinbelow, the references between brackets ([ ]) refer to the list of references presented at the end of the text.

### BACKGROUND

A large number of construction vehicles have tires of large size. These vehicles are for example articulated haulers, rigid dumpers, container-handling equipment in ports or multi-wheel cranes. The unit cost of these tires is substantial and their manufacturing period is very long. It is therefore important to ensure that these tires have a long service life in order to limit direct costs and downtime.

It was observed that the temperature and the pressure were essential factors that influenced the service life of a tire. It is therefore important to monitor at least these parameters during the use of the vehicle.

Document US 2007/0057478 A1 [D1] shows a monitoring system comprising sensors installed inside tires which communicate wirelessly with a relay terminal placed on board the vehicle. The sensors measure the temperature and the pressure of the tire. The measurements are transmitted via a wireless communication by the sensor to the relay terminal, then via another wireless communication to a central station separate from the vehicle. The central station can also transmit instructions to the vehicle, in order for example to take restrictive measures concerning the use in order to preserve the tires. These instructions are based on the analysis of the information received, by comparison for example with pressure and temperature alert thresholds.

Document EP 1 172 237 A2 [D2] also shows a monitoring system of the pressure and of the temperature inside the tire, transmitted wirelessly to a central unit on board the vehicle and processed by this central unit. The data is stored in a memory. The data can be consulted using a mobile terminal connected via a wireless connection such as a connection via Bluetooth.

Such systems do not provide full satisfaction. In the system of the document [D1], data can be lost if at the time when the data is called, the communication between the vehicle and the central station is not established. The data in the system of the document [D2] is stored, but can be transferred only to another device that has an application provided to receive it.

There is therefore a genuine need for a tire monitoring system making it possible to transfer that data simply and reliably.

### DESCRIPTION OF THE INVENTION

With these objectives in mind, a tire monitoring system mounted on a vehicle is provided with the system comprising at least one sensor mounted in one of the tires in order to measure at least the temperature and the pressure of the tire, means of transmitting the data measured to a central unit mounted on board the vehicle, with the central unit comprising means of storing the data acquired at various instants, comprising a USB connector, and in that the central unit is programmed to, when a removable memory device is connected to the USB port, transfer at least a portion of the data stored in the central unit to the memory device.

As such, the transfer of the data to an information processing unit is free from the potential problems of transmission via radiofrequencies. The data, once stored in the memory device, can still be transferred from the memory device to a processing unit. The memory device, such as a “flash” memory stick or hard drive is light and not cumbersome. It can be transported easily, including in the passenger compartment of a construction vehicle. The data recovered as such makes it possible to analyze the history of the tires of the vehicle and to provide measures for repair or change by minimizing the timeframes and intervention time or to modify the instructions for using the vehicle.

According to an embodiment, the data stored in the central unit is marked as having been sent after it is transferred to the memory device. As such, only data that is not marked as sent is transferred, which avoids duplicating the data.

In a complementary manner, the central unit is programmed to identify at least one update element on the memory device and to apply the update after the transfer of the data. As such, a simple way to update the system is proposed, by placing update elements on the memory device. The system is programmed to automatically search for these elements and process them as such.

By way of examples, the update element comprises at least one configuration file, at least one program or temporal data to update an internal clock of the central unit. The configuration file is used by a program in order to adapt its behavior according to variations scheduled in advance. A new program makes it possible to entirely modify the functions of the system. An internal clock makes it possible to date the instants at which the data was acquired and stored. Such a clock can drift and it is useful to readjust it to the real time.

According to another embodiment, the central unit processes the data in order to generate alerts for the driver of the vehicle. The processing of the information is carried out automatically as close as possible to the source of the data and is not dependant on wireless connections. The user can be informed very quickly of degradation in the operating conditions of the tires.

In a complementary manner, the central unit comprises means for signaling in order to inform the user that the data transfer is complete and that the memory device can be removed. Means are as such available to ensure that all of the data and update elements are properly transferred.

The means for signaling are for example a display, a lighted device or a warning buzzer.

Advantageously, the means for signaling are integrated into an interface unit separate from the central unit and further comprising the USB connector. The interface unit is typically placed in a cab of the vehicle where it is protected and where it can exchange information with the driver of the vehicle.

The alerts can also be provided to the driver via the means for signaling.

Other advantages can also appear to those skilled in the art when reading the examples hereinbelow, illustrated by the annexed figures, provided for the purposes of information.

### BRIEF DESCRIPTION OF THE FIGURES

FIG. 1 is a diagrammatical view of a vehicle comprising a tire monitoring system in accordance with an embodiment of the invention.

FIG. 2 is a view of a display which is a part of the system of FIG. 1.

FIG. 3 is a logic diagram of the program implemented by the system of FIG. 1.

FIG. 4 is a subpart of the diagram of FIG. 3.

### DETAILED DESCRIPTION

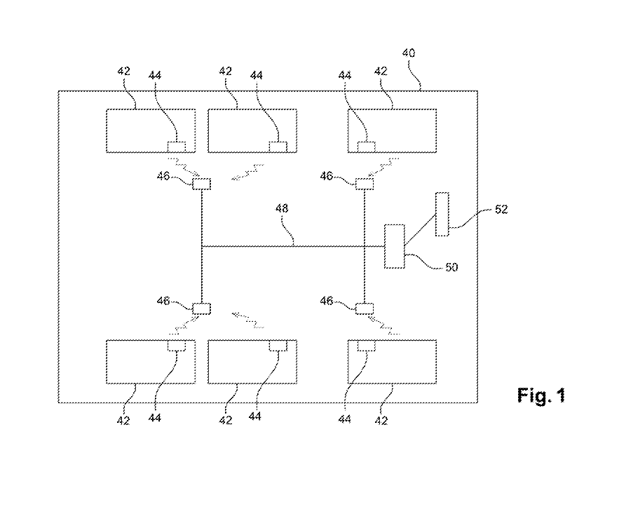

A vehicle 40 comprising a tire monitoring system in accordance with an embodiment of the invention is shown in FIG. 1 diagrammatically. The vehicle comprises six tires 42, each tire 42 being provided with a pressure and temperature sensor 44. The vehicle comprises four relay terminals 46 fixed on the vehicle in the vicinity of the tires 42 in order to communicate with the sensors 44 and recover the measurements taken by the latter. The relay terminals 46 are connected in a wired manner by means of transmission such as a digital bus 48 to a central unit 50 which receives the information from the sensors 44. The central unit 50 is connected to an interface unit 52, placed in the cab of the vehicle 40.

The central unit 50 comprises means of processing the information received and means of storage to memorize the data coming from the sensors 44. The means of storage moreover store a program of instructions for the central unit 50 and configuration files that interact with the program in order to adapt its behavior. The central unit 50 further comprises a clock, not shown, which provides information on the current date and time.

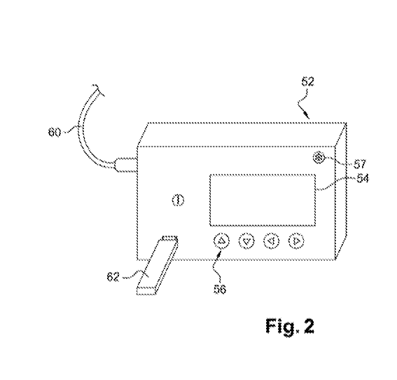

The interface unit 52 comprises, as shown in FIG. 2, a display 54 to display messages intended for the user, control buttons 56 to receive commands from the user, a warning buzzer 57 to sound an audible signal and a USB connector 58. It further comprises a cable 60 for the electrical connection with the central unit 50. A memory device 62 such as a USB key is also shown being used, when it is in place in the USB connector 58.

### Operation

When the program is executed on the central unit 50, data is requested on a regular basis from the sensors 44 and, once acquired and transmitted to the central unit 50, stored in the means of storage, in addition associated with information on the date and time of acquisition, coming from the clock. The data is also processed, by comparing it for example with thresholds, in order to determine if alerts have to be generated. If the pressure or the temperature exceeds predetermined thresholds, a message is displayed on the display 54 and an audible signal is generated with the warning buzzer 57.

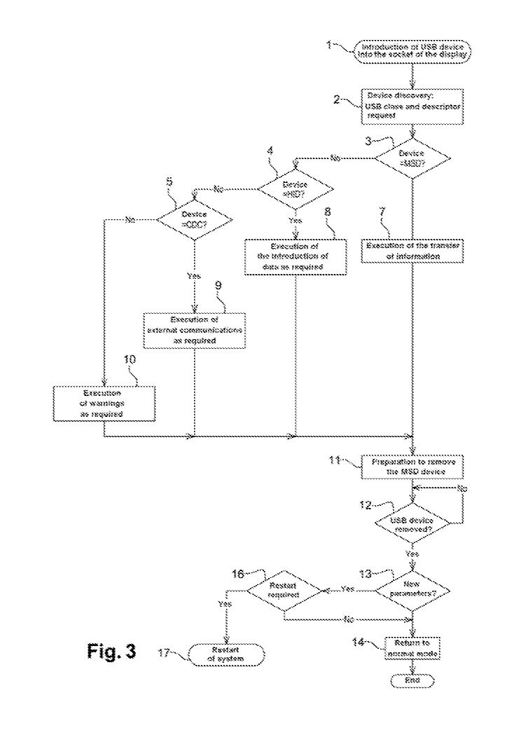

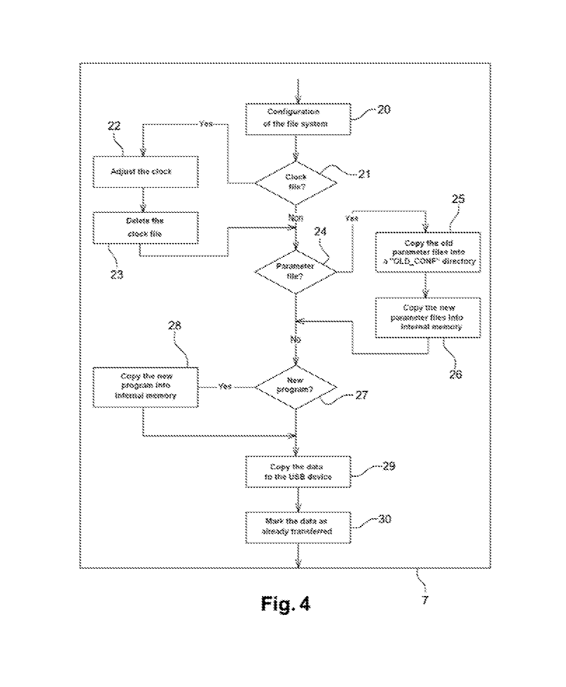

When a device is introduced into the USB connector 58, an event is triggered and a processing such as is depicted in FIGS. 3 and 4 is initiated by the step 1.

The step 2 is triggered wherein information on the device is required, in particular the class of the device, but also the identifiers of the manufacturer and of the product, the serial number or the electrical power requirements.

A test step 3 is then executed wherein it is verified whether the class is of the “MSD” type, which designates a memory device (“Mass Storage Device”). If the response is positive, control passes to step 7, otherwise control is passed to the test step 4. The response is positive when the device is the memory device 62.

During the test step 4, it is verified whether the class is of the “HID” type, which designates an interface device (“Human Interface Device”). This can be a keyboard, a mouse, additional buttons, a barcode reader or a dot matrix display or a measuring device. The measuring device can be for example a depth gauge in order to measure the remaining depth of the tread patterns of the tires. If the response is positive, control is passed to the step 8, wherein the data to be entered is acquired and stored, in a manner for which the details are not provided here.

If the response is negative, control is passed to the test step 5, wherein it is verified if the class is of the “CDC” type, which designates a device for communicating with an external device (“Communications device class”). This can be a serial communications device, a communications device using a wireless telephone network, responding for example to the GSM/GPRS or UMTS standards, or a communications device using a wired network such as a CAN bus, LIN or Ethernet. Such a device is used for example to allow for the retrieval of data, the configuration or the updating of the system, during the step 9.

If the response is negative, control is passed to the step 10, wherein it is considered that any other device class is not processed by the system and must be removed. A message is therefore transmitted to the display 54 for this purpose.

The step 7 will now be described in detail in reference to FIG. 4.

In a step 20, the system is configured to access the file system of the memory device 62.

In the test step 21, the existence of a clock file is checked. The clock file has for example a predetermined name in such a way that the clock file can be recognized in this way. If it is not present, control passes directly to the test step 24. If it is present, control passes to step 22 wherein the file is read in order to extract date and time information from it, and the clock of the central unit 50 is updated with this temporal information. In the following step 23, the clock file is deleted, so that it is no longer used to incorrectly update the clock. Control then passes to the test step 24.

During the test step 24, it is verified whether there exists one or more configuration files. If there are none, control passes directly to the test step 27. If one or more exists, control passes to the step 25 wherein the files that must be replaced are copied into a backup directory, named for example “OLD_CONF”, in the means of storage. In the following step 26, the configuration files are copied from the memory device 62 to the means of storage, replacing the previous files. Control then passes to test step 27.

During the test step 27, it is verified whether a new program of instructions exists. If one does not exist, control passes directly to the step 29. If one exists, control passes to step 28 wherein the new program of instructions is copied from the memory device 62 to the means of storage.

Control then passes to step 29, wherein the data stored in the means of storage are transferred to the memory device 62. Only the data that is not yet marked as having been transferred is copied to the memory device 62. The data is for example written in a new file with a predetermined name.

Then, during the step 30, the data that has just been transferred are marked in the means of storage as having been transferred. As such a history of the measurements is retained, and during the next transfer operation, only the new measurements will be transferred.

Referring again to FIG. 3, after the steps 7, 8, 9 or 10, control passes to the step 11 wherein the removal of the memory device 62 is prepared. This preparation consists in finishing the writing of the data that may still be left to write from a buffer memory, in deleting the information from the file system of the memory device 62 and in signaling via means for signaling that the memory device 62 can be removed. The means for signaling are for example the display 54 whereon a written message is made to appear and the warning buzzer 57 which sounds a beep.

In the test step 12, the removal of the memory device 62 is awaited. As soon as it is removed, it is verified during the test step 13 whether new configuration files or a new program was transferred. If this is the case, it is verified during the step 16 whether a restart of the central unit 50 is required. If such is the case, the restart is initiated. Otherwise, the system returns to a normal mode during the step 14.

It is therefore observed that when a USB memory device 62 is used, the operator need only carry out the connecting of the device to the interface unit 52, and all of the operations are carried out without operator intervention, automatically. These operations are therefore greatly facilitated and made reliable.

### LIST OF REFERENCES

D1: US 2007/0057478 A1 published on Mar. 15, 2007
D2: EP 1 172 237 A2 published on Jan. 16, 2002

1. A tire monitoring system mounted on a vehicle, the system comprising at least one sensor mounted in one of the tires in order to measure at least the temperature and the pressure of the tire, means of transmitting data measured to a central unit mounted on board the vehicle, the central unit comprising means of storing data acquired at various instants, wherein the system comprises a USB connector, and wherein the central unit is programmed to, when a removable memory device is connected to the USB port, transfer at least one portion of the data stored in the central unit to the memory device.

2. The system according to claim 1, wherein the data stored in the central unit is marked as having been sent after it is transferred to the memory device.

3. The system according to claim 1, wherein the central unit is programmed to identify at least one update element on the memory device and to apply the update after the transfer of data.

4. The system according to claim 3, wherein the update element comprises at least one configuration file.

5. The system according to claim 3, wherein the update element comprises at least one program.

6. The system according to claim 3, wherein the update element comprises temporal data in order to update an internal clock of the central unit.

7. The system according to claim 1, wherein the central unit processes the data in order to generate alerts for the driver of the vehicle.

8. The system according to claim 1, wherein the central unit comprises means for signaling in order to inform the user that the transfer of data is complete and that the memory device can be removed.

9. The system according to claim 8, wherein the means for signaling are chosen in a group comprising a display, a lighted device and a warning buzzer.

10. The system according to claim 8, wherein the means for signaling are integrated into an interface unit separate from the central unit and further comprising the USB connector.

11. The system according to claim 3, wherein the alerts are provided to the driver by the means for signaling.

12. A tire monitoring system mounted on a vehicle, the system comprising at least one sensor mounted in one of the tires in order to measure at least the temperature and the pressure of the tire, a digital bus transmitting data measured to a central unit mounted on board the vehicle, the central unit having program storage to store data acquired at various instants, wherein the system comprises a USB connector, and wherein the central unit is programmed to, when a removable memory device is connected to the USB port, transfer at least one portion of the data stored in the central unit to the memory device.

13. The system according to claim 12, wherein the data stored in the central unit is marked as having been sent after it is transferred to the memory device.

14. The system according to claim 12, wherein the central unit is programmed to identify at least one update element on the memory device and to apply the update after the transfer of data.

15. The system according to claim 14, wherein the update element comprises at least one configuration file.

16. The system according to claim 14, wherein the update element comprises at least one program.

17. The system according to claim 14, wherein the update element comprises temporal data in order to update an internal clock of the central unit.

18. The system according to claim 12, wherein the central unit processes the data in order to generate alerts for the driver of the vehicle.

19. The system according to claim 12, wherein the central unit comprises a signal in order to inform the user that the transfer of data is complete and that the memory device can be removed, wherein the signal is chosen from the group consisting of a display, a lighted device and a warning buzzer.

20. The system according to claim 19, wherein the signal is integrated into an interface unit separate from the central unit and further comprising the USB connector.
